(19) United States
(12) Patent Application Publication
(10) Pub. No.: US 2011/0018587 A1
(43) Pub. Date: Jan. 27, 2011

(54) METHOD AND CIRCUIT FOR CONFIGURING PIN STATES

(76) Inventor: Bo Li, Shenzhen (CN)

Correspondence Address: Huawei/BHGL, P.O. Box 10395, Chicago, IL, 60610, US

(21) Appl. No.: 12/840,940

(22) Filed: Jul. 21, 2010

(30) Foreign Application Priority Data
Jul. 24, 2009 (CN) 200910161511.0

(51) Int. Cl. G05F 3/02

(52) U.S. Cl. 327/74

(57) ABSTRACT

The present disclosure relates to an electronic technology and discloses a method and circuit for configuring pin states. The method for configuring pin states includes: establishing a connection between a pin and a variable resistor; loading a fixed voltage on the pin, and detecting intensity of currents generated by the variable resistor under different resistance; comparing the detected current intensity with at least two different reference values, and outputting corresponding pin states according to the comparison results; or loading a fixed current on the pin, and detecting voltages generated by the variable resistor under different resistance; comparing the detected voltages with at least two different reference values, and outputting corresponding pin states according to the comparison results. With the present disclosure, multiple pin states may be easily obtained.

### CROSS-REFERENCE TO RELATED APPLICATION

This application claims priority to Chinese Patent Application No. 200910161511.0, filed on Jul. 24, 2009, which is hereby incorporated by reference in its entirety.

### TECHNICAL FIELD

The present disclosure relates to an electronic technology, and in particular, to a method and circuit for configuring pin states.

### BACKGROUND

To implement more functions in a same chip and improve the price performance ratio of the chip, most chips provide a function of configuring pin states during the manufacturing. The chip may be in different working states according to different pin states so that the chip can provide different functions or performance. Two methods are generally available for configuring the pin states. The first method is configuring different voltages for the pin, with different voltages indicating different pin states. The second method is configuring the pin states by changing the content of the register inside the chip through an external processor.

FIG. 1 shows a structure of a circuit for configuring pin states in the prior art. As shown in FIG. 1, the circuit is based on the first method and includes external resistors R1 and R2, a comparator 1, and a comparator 2. The reference voltage Vref1 of comparator 1 is different from the reference voltage Vref2 of comparator 2. When only R1 is used, the pin state is low level. When only R2 is used, the pin state is high level. When R1 and R2 are used concurrently, the pin state is intermediate level. Comparator 1 and comparator 2 may be used to determine the pin state. The logic signal REG1 output by comparator 1 and the logic signal REG2 output by comparator 2 are combined to indicate the pin state. In addition, the pin state is sent to other circuits in the chip to implement corresponding functions in the pin state.

The disclosure presented herein addresses at least the problems and shortcomings disclosed and discussed in the prior art.

### SUMMARY

The present disclosure provides a method and circuit for configuring pin states to easily obtain multiple pin states.

To achieve the foregoing objective, embodiments of the present disclosure provide the following technical solution:

A method for configuring pin states includes:

loading a fixed voltage on a pin connected to a variable resistor, and detecting intensity of currents generated by the variable resistor under different resistance; comparing the current intensity with at least two different reference values, and outputting corresponding pin states according to the comparison results; or

loading a fixed current on the pin, and detecting voltages generated by the variable resistor under different resistance; comparing the voltages with at least two different reference values, and outputting corresponding pin states according to the comparison results.

Another method for configuring pin states includes:

loading a variable current on a pin connected to a variable resistor, and detecting voltages generated by the variable resistor under different resistance; comparing the voltages with a reference value, and outputting corresponding pin states according to the comparison results.

A circuit for configuring pin states includes a pin, a variable resistor, and a detection circuit, where:

the first end of the pin is connected to the first end of the variable resistor, the second end of the variable resistor is connected to the earth, and the second end of the pin is connected to the input end of the detection circuit; and

the detection circuit is configured to: load a fixed voltage on the second end of the pin, compare the current intensity with at least two different reference values when detecting intensity of currents generated by the variable resistor under different resistance, and output corresponding pin states according to the comparison results; or

the detection circuit is configured to: load a fixed current on the second end of the pin, compare the voltages with at least two different reference values when detecting voltages generated by the variable resistor under different resistance, and output corresponding pin states according to the comparison results.

Another circuit for configuring pin states includes a pin, a variable resistor, and a detection circuit, where:

the first end of the pin is connected to the first end of the variable resistor, the second end of the variable resistor is connected to the earth, and the second end of the pin is connected to the input end of the detection circuit; and

the detection circuit is configured to: load a fixed current on the second end of the pin, compare the voltages with a reference value when detecting voltages generated by the variable resistor under different resistance, and output corresponding pin states according to the comparison results.

In embodiments of the present disclosure, the variable resistor is connected to the pin. In this way, a fixed voltage may be loaded on the variable resistor so that the variable resistor generates different currents under different resistance; different pin states are obtained according to the comparison between the current intensity and the reference value. In addition, a fixed or variable current may be loaded on the variable resistor so that the variable resistor generates different voltages under different resistance; different pin states are obtained according to the comparison between the voltages and the reference values. In embodiments of the present disclosure, different pin states may be represented by different resistance of the variable resistor. Because the resistance of the variable resistor may range from several tens of ohms to hundreds of kilohms, different pin states may be easily obtained.

### BRIEF DESCRIPTION OF THE FIGURES

To make the problems associated with the prior art and the technical solution provided by the present disclosure easier to comprehend, the accompanying figures further illustrate the embodiments of the present disclosure or teachings of the prior art are outlined below. The accompanying figures are provided as an example of the inventive concepts, elements, and features discussed and embodied herein, and those skilled in the art can adapt the disclosed inventive concepts, elements, and features for use in other embodiments.

FIG. 1 shows a structure of a circuit for configuring pin states in the prior art;

FIG. 2 is a flowchart of a method for configuring pin states in a first embodiment of the present disclosure;

FIG. 3 is a flowchart of a method for configuring pin states in a second embodiment of the present disclosure;

FIG. 4 shows a structure of a circuit for configuring pin states in a third embodiment of the present disclosure;

FIG. 5 shows a structure of a detection circuit in the third embodiment of the present disclosure;

FIG. 6 shows a structure of another detection circuit in the third embodiment of the present disclosure;

FIG. 7 shows a structure of a detection circuit in a fourth embodiment of the present disclosure;

FIG. 8 shows a structure of a circuit for configuring pin states in a fifth embodiment of the present disclosure;

FIG. 9 shows a structure of a circuit for configuring pin states in a sixth embodiment of the present disclosure; and

FIG. 10 shows a structure of a circuit for configuring pin states in a seventh embodiment of the present disclosure.

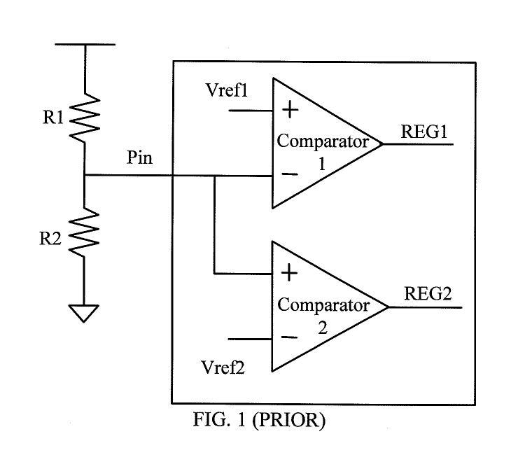

### DETAILED DESCRIPTION OF THE EMBODIMENTS

The technical solution of the present disclosure is hereinafter described in detail with reference to the accompanying figures. It is evident that the embodiments are only exemplary embodiments of the present disclosure and the present disclosure is not limited to such embodiments. Other embodiments that those skilled in the art derive based on embodiments of the present disclosure also fall within the scope of protection of the present disclosure.

### First Embodiment

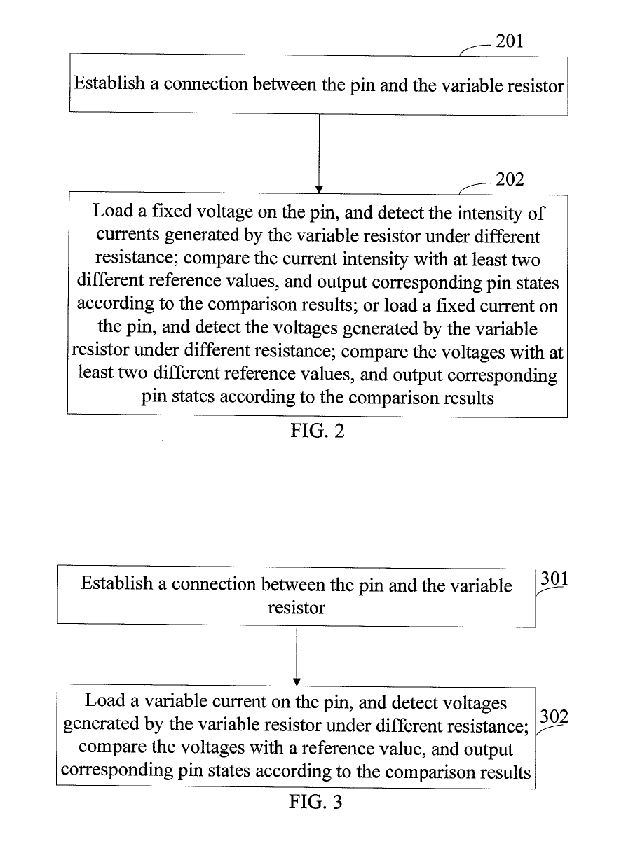

FIG. 2 is a flowchart of a method for configuring pin states in the first embodiment of the present disclosure. As shown in FIG. 2, the method may include the following steps:

Step 201: Establish a connection between the pin and the variable resistor.

For example, the resistance of the variable resistor may range from several tens of ohms to hundreds of kilohms.

Step 202: Load a fixed voltage on the pin, and detect the intensity of currents generated by the variable resistor under different resistance; compare the current intensity with at least two different reference values respectively, and output corresponding pin states according to the comparison results; or load a fixed current on the pin, and detect the voltages generated by the variable resistor under different resistance; compare the voltages with at least two different reference values respectively, and output corresponding pin states according to the comparison results.

For example, the process of comparing the detected current intensity with at least two different reference values and outputting corresponding pin states according to the comparison results in step 202 may include the following steps:

A. Compare the current intensity with at least two different reference values, and output logic signals obtained according to the comparison results, for example, 1 or 0.

B. Use the logic signal combinations as the pin states.

For example, if there are four different reference values of current intensity, each logic signal obtained according to the comparison results may be combined into five pin states, such as 0000, 1000, 1100, 1110, and 1111. That is, five pin states may be configured on a pin. Accordingly, the chip may implement five functions according to the five pin states.

For example, multiple P-type metal oxide semiconductors (PMOSs) and multiple N-type mental oxide semiconductors (NMOSs) may be used to build a current comparison circuit. In this way, the detected current intensity may be compared with each reference value.

For example, the process of comparing the detected voltages with at least two different reference values and outputting corresponding pin states according to the comparison results in step 202 may include the following steps:

C. Compare the detected voltages with at least two different reference values respectively, and output logic signals obtained according to the comparison results, for example, 1 or 0.

D. Use the logic signal combinations as the pin states.

For example, if there are five different reference voltages, each logic signal obtained according to the comparison results may be combined into six pin states, such as 00000, 10000, 11000, 11100, 11110, and 11111. That is, six pin states may be configured on a pin. Accordingly, the chip may implement six functions according to the six pin states.

For example, a voltage comparison circuit may be built by using multiple comparators with different reference voltages. In this way, the detected voltages may be compared with each reference voltage.

What has been described above is method for configuring pin states in the first embodiment of the present disclosure. In the first embodiment, the variable resistor is connected to the pin so that a fixed voltage may be loaded on the variable resistor; the variable resistor generates different currents under different resistance; different pin states are obtained according to the comparison between the current intensity and the reference value; a fixed current may also be loaded on the variable resistor; the variable resistor generates different voltages under different resistance; and different pin states are obtained according to the comparison between different voltages and reference values. Because the resistance of the variable resistor may range from several tens of ohms to hundreds of kilohms, different pin states may be obtained easily.

Optionally, the preceding step 201 may be omitted, and step 202 is executed directly in the circuit between the pin and the variable resistor. This solves the same technical issue and achieves the same technical effect.

### Second Embodiment

FIG. 3 is a flowchart of a method for configuring pin states in the second embodiment of the present disclosure. As shown in FIG. 3, the method may include the following steps:

Step 301: Establish a connection between the pin and the variable resistor.

For example, the resistance of the variable resistor may range from several tens of ohms to hundreds of kilohms.

Step 302: Load a variable current on the pin, and detect voltages generated by the variable resistor under different resistance; compare the voltages with a reference value, and output corresponding pin states according to the comparison results.

For example, the process of comparing the detected voltages with the reference value and outputting the pin states according to the comparison results in step 302 may include the following steps:

Compare the voltages with the reference value; output logic signals obtained according to the comparison results, for example, 1 or 0; and use the logic signals as the pin states.

What has been described above is a method for configuring pin states in the second embodiment of the present disclosure. In the second embodiment, the variable resistor is connected to the pin so that a variable current may be loaded on the variable resistor; the variable resistor generates different voltages under different resistance; different pin states are obtained according to the comparison between different voltages and the reference value. Because the resistance of the variable resistor may range from several tens of ohms to hundreds of kilohms, different pin states may be obtained easily.

### Third Embodiment

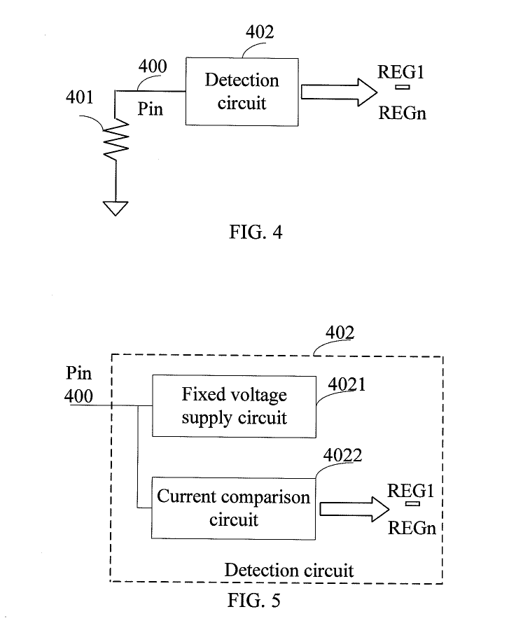

FIG. 4 shows a structure of a circuit for configuring pin states in the third embodiment of the present disclosure. As shown in FIG. 4, the circuit may include: a pin 400, a variable resistor 401, and a detection circuit 402.

The first end of the pin 400 is connected to the first end of the variable resistor 401, and the second end of the variable resistor 401 is connected to the earth. The second end of the pin 400 is connected to the input end of the detection circuit 402.

The detection circuit 402 is configured to: load a fixed voltage on the second end of the pin 400, compare the current intensity with at least two different reference values respectively when detecting intensity of currents generated by the variable resistor 401 under different resistance, and output corresponding pin states REG1 to REGn according to the comparison results.

Or, the detection circuit 402 is configured to: load a fixed current on the second end of the pin 400, compare the voltages with at least two different reference values respectively when detecting voltages generated by the variable resistor 401 under different resistance, and output corresponding pin states REG1 to REGn according to the comparison results.

For example, the resistance of the variable resistor may range from several tens of ohms to hundreds of kilohms.

FIG. 5 shows a structure of a detection circuit in the third embodiment of the present disclosure. As shown in FIG. 5, the detection circuit may include a fixed voltage supply circuit 4021 and a current comparison circuit 4022.

The fixed voltage supply circuit 4021 is connected to the second end of the pin 400 and configured to load a fixed voltage on the second end of the pin 400.

For example, the fixed voltage supply circuit 4021 may provide a fixed voltage, where the fixed voltage includes but is not limited to a band-gap voltage and a power supply voltage.

The current comparison circuit 4022 is connected to the second end of the pin and configured to: detect intensity of currents generated by the variable resistor 401 under different resistance, compare the current intensity with at least two different reference values respectively, and output corresponding pin states REG1 to REGn according to the comparison results.

For example, the current comparison circuit 4022 may be composed of multiple PMOSs and multiple NMOSs. In this way, the detected current intensity may be compared with each reference value.

For example, the current comparison circuit 4022 may compare the detected current intensity with at least two different reference values respectively, output logic signals obtained according to the comparison results, for example, 1 or 0, and use the logical signal combinations REG1 to REGn as the pin states.

For example, if there are four different reference values, the current comparison circuit 4022 may compare the detected current intensity with the four reference values respectively, and output four logic signals. The four logic signals may be combined into five pin states, such as 0000, 1000, 1100, 1110, and 1111. That is, five pin states may be configured on a pin. Accordingly, the chip may implement five functions according to the five pin states.

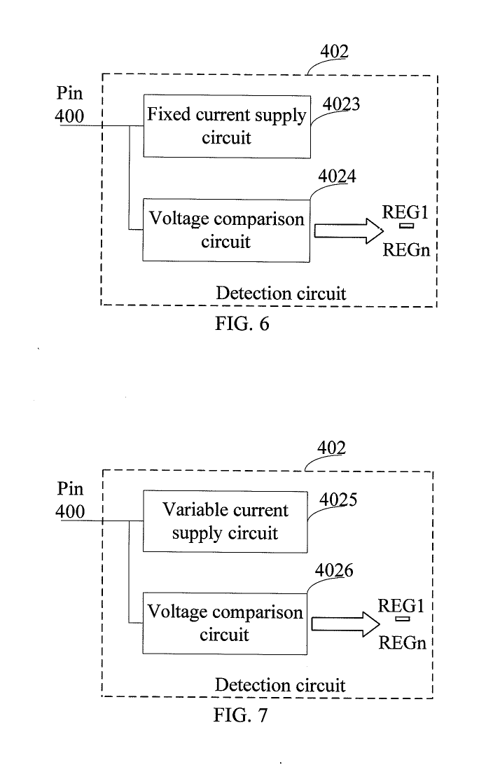

FIG. 6 shows a structure of another detection circuit in the third embodiment of the present disclosure. As shown in FIG. 6, the detection circuit may include:

a fixed current supply circuit 4023 connected to the second end of the pin 400, configured to load a fixed current on the second end of the pin 400;

a current comparison circuit 4024 connected to the second end of the pin 400, configured to: detect voltages generated by the variable resistor 401 under different resistance, compare the voltages with at least two different reference values, and output corresponding pin states according to the comparison results.

For example, the voltage comparison circuit 4024 may be built by using multiple comparators with different reference voltages. In this way, the detected voltages may be compared with each reference voltage.

For example, the voltage comparison circuit 4024 may compare the detected voltages with at least two different reference values, output logic signals obtained according to the comparison results, for example, 1 or 0, and use the logical signal combinations REG1 to REGn as the pin states.

For example, if there are five different reference voltages, the voltage comparison circuit 4024 may compare the detected voltages with each reference value respectively and obtain five logic signals, and combine the five logic signals into REG1 to REGn. Thus, six pin states may be obtained. That is, six pin states may be configured on a pin. Accordingly, the chip may implement six functions according to the six pin states.

What has been described is a circuit for configuring pin states in the third embodiment of the present disclosure. In the third embodiment, the variable resistor is connected to the pin so that a fixed voltage may be loaded on the variable resistor; the variable resistor generates different currents under different resistance; different pin states are obtained according to the comparison between the current intensity and the reference value; a fixed current may also be loaded on the variable resistor; the variable resistor generates different voltages under different resistance; and different pin states are obtained according to the comparison between different voltages and reference values. Because the resistance of the variable resistor may range from several tens of ohms to hundreds of kilohms, different pin states may be obtained easily.

### Fourth Embodiment

This embodiment describes a circuit for configuring pin states based on the circuit shown in FIG. 4.

As shown in FIG. 4, the circuit may include a pin 400, a variable resistor 401, and a detection circuit 402.

The first end of the pin 400 is connected to the first end of the variable resistor 401, and the second end of the variable resistor 401 is connected to the earth. The second end of the pin 400 is connected to the input end of the detection circuit 402.

The detection circuit 402 is configured to: load a fixed current on the second end of the pin 400, compare the voltages with a reference value when detecting voltages generated by the variable resistor 401 under different resistance, and output pin states REG1 to REGn according to the comparison results.

For example, the resistance of the variable resistor may range from several tens of ohms to hundreds of kilohms.

FIG. 7 shows a structure of another detection circuit in the fourth embodiment of the present disclosure. As shown in FIG. 7, the detection circuit 402 may include a variable current supply circuit 4025 and a voltage comparison circuit 4026.

The variable current supply circuit 4025 is connected to the second end of the pin 400 and configured to load a variable current on the second end of the pin 400;

For example, the variable current supply circuit 4025 may be composed of multiple PMOSs and a switch.

The voltage comparison circuit 4026 is connected to the second end of the pin and configured to: detect voltages generated by the variable resistor 401 under different resistance, compare the voltages with a reference value, and output pin states REG1 to REGn according to the comparison results.

For example, the voltage comparison circuit 4026 may be built by using a comparator and multiple switches. In this way, the detected voltages may be compared with the reference value.

For example, the voltage comparison circuit 4026 may compare the voltages with the reference value, output logic signals obtained according to the comparison between the voltages and the reference voltage value, for example, 1 or 0, and use the logic signals as the pin states.

What has been described above is a circuit for configuring pin states in the fourth embodiment of the present disclosure. In the fourth embodiment, the variable resistor is connected to the pin so that a variable current may be loaded on the variable resistor; the variable resistor generates different voltages under different resistance; different pin states are obtained according to the comparison between different voltages and the reference value. Because the resistance of the variable resistor may range from several tens of ohms to hundreds of kilohms, different pin states may be obtained easily.

### Fifth Embodiment

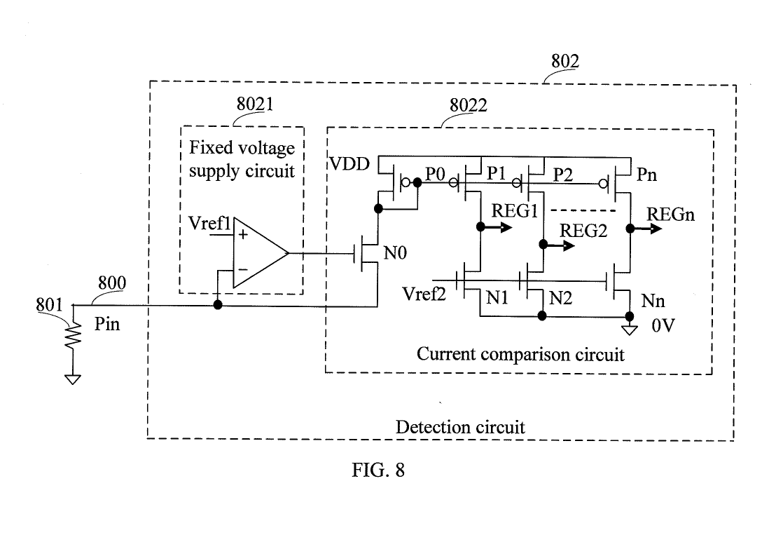

FIG. 8 shows a structure of a circuit for configuring pin states in the fifth embodiment of the present disclosure. As shown in FIG. 8, the circuit may include: a pin 800, a variable resistor 801, and a detection circuit 802.

The first end of the pin 800 is connected to the first end of the variable resistor 801, and the second end of the variable resistor 801 is connected to the earth. The second end of the pin 800 is connected to the input end of the detection circuit 802.

As shown in FIG. 8, the detection circuit 802 may include a fixed voltage supply circuit 8021 and a current comparison circuit 8022.

The fixed voltage supply circuit 8021 is connected to the second end of the pin 800 and configured to load a fixed voltage Vref1 on the second end of the pin 800.

For example, the fixed voltage supply circuit 8021 may provide voltages such as a band-gap voltage and a power supply voltage.

The current comparison circuit 8022 is connected to the second end of the pin 800 and configured to: detect intensity of currents generated by the variable resistor 801 under different resistance, compare the voltages with at least two different reference values respectively, and output corresponding pin states according to the comparison results.

For example, the current comparison circuit 8022 is built by using multiple PMOSs and multiple NMOSs. In this way, the detected current intensity may be compared with each reference value. The currents that pass through PMOS P0 are generated under different resistance and mirrored to P1 to Pn, which will output mirror currents. P1 to Pn are connected to N1 to Nn in series. The trigger voltages of n NMOSs are set to a fixed voltage Vref2. The n NMOSs are set in different width length ratios so that the currents passing through each NMOS are generated according to a preset level. In this way, after the current passing through the Pn is compared with the current passing through the Nn in each pair of MOSs, the logic level of each pair of MOSs may be output; the pin states may be output according to the comparison results.

Specifically, due to the functions of the comparators in the fixed voltage supply circuit 8021, the voltage in the variable resistor 801 is Vref1. Thus, the intensity of currents generated by the variable resistor 801 is Vref1/R.

The current of PMOS P0 is equal to the current generated by the variable resistor 801, that is, Vref1/R.

If the width length ratios of the PMOSs P0 to Pn are equal, the currents passing through the P1 to Pn are equal to those passing through the P0 according to the current mirror principle. That is, the current intensity is also equal to Vref1/R. Vref2 indicates the trigger voltage of NMOS N1. When NMOSs N1 to Nn are changed according to the width length ratio, the currents on those NMOSs are also changed according to the ratio. If the current passing through the P1 is higher than the current passing through the N1, the voltage of the REG1 output by the P1 may increase to a level close to the VDD, that is, high level, which is equivalent to logic 1. If the current passing through the P1 is lower than the current passing through the N1, the voltage of the REG1 may decrease to 0 V, which is equivalent to logic 0. This principle is applicable to REG2 to REGn.

The logic signal combinations REG1 to REGn obtained according to the comparison results may be as follows: 0000, 0001, 0011, 0111, and 1111 (supposing n is equal to 4).

The absolute value error of the Vref1 may be within ±20%. The general resistance accuracy of the variable resistor 801 is 5% and 1%. If the non-ideal features of the comparators are considered, the absolute value error of the current generated by the variable resistor 801 may be within ±30%. If the judgment reliability is considered, the judgment step of the resistance of the variable resistor 801 may be designed to be 3.16 times. For example, if 100 ohms indicate a state, ±30% means 70 ohms to 130 ohms; if 316 ohms indicate another state, ±30% means 221 ohms to 411 ohms. Then, the range between 130 ohms and 221 ohms may be used as the marker space for increasing the judgment reliability. For ease of selection, the resistance may be increased by ±10%. That is, 90 ohms to 100 ohms indicate a state, while 284 ohms to 348 ohms indicate another state. Thus, it is easy to determine that the marker space is 143 ohms to 199 ohms.

If 3.16 times are used as the judgment step of the resistance, the range between 50 ohms and 500 kilohms may indicate nine states, namely, 50, 158, 500, 1.58 k, 5 k, 15.8 k, 50 k, 158 k, and 500 k. If 0 ohm and an infinite value (that is, no resistance exists) are added, 11 states are available.

Optionally, in the preceding embodiment, the width length ratios of PMOSs P1 to Pn may be changed according to an expected ratio, while the width length ratios of NMOSs N1 to Nn remain unchanged. After the current intensity is compared, the obtained logic signal combinations REG1 to REGn may be as follows: 0000, 0001, 0011, 0111, and 1111 (supposing n is equal to 4).

What has been described above is a circuit for configuring pin states in the fifth embodiment of the present disclosure. In the fifth embodiment, the variable resistor is connected to the pin so that a fixed voltage may be loaded on the variable resistor; the variable resistor generates different currents under different resistance; different pin states are obtained according to the comparison between the current intensity and the reference value. Because the resistance of the variable resistor may range from several tens of ohms to hundreds of kilohms, different pin states may be obtained easily.

### Sixth Embodiment

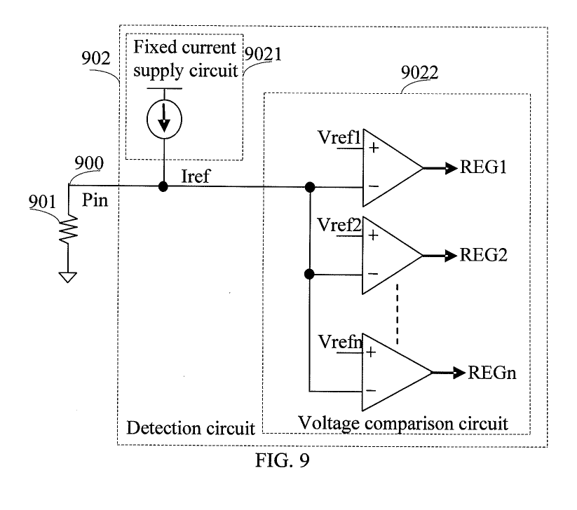

FIG. 9 shows a structure of a circuit for configuring pin states in the sixth embodiment of the present disclosure. As shown in FIG. 9, the circuit may include: a pin 900, a variable resistor 901, and a detection circuit 902.

The first end of the pin 900 is connected to the first end of the variable resistor 901, and the second end of the variable resistor 901 is connected to the earth. The second end of the pin 900 is connected to the input end of the detection circuit 902.

As shown in FIG. 9, the detection circuit 902 may include:

a fixed current supply circuit 9021 connected to the second end of the pin 900, configured to load a fixed current on the second end of the pin 900; and

a current comparison circuit 9022 connected to the second end of the pin 900, configured to: detect voltages generated by the variable resistor 901 under different resistance, compare the voltages with at least two different reference values respectively, and output corresponding pin states according to the comparison results.

The voltage comparison circuit 9022 may be built by using multiple comparators with different reference voltages Vref1 to Vrefn. In this way, the detected voltages may be compared with each reference voltage.

The Iref indicates a fixed current generated by the fixed current supply circuit 9021. When this fixed current is loaded on the second end of the pin 900, the variable resistor 901 may obtain different voltages under different resistance.

Different voltages obtained by the variable resistor 901 under different resistance are compared with different reference voltages Vref1 to Vrefn, and then corresponding pin states may be obtained according to the comparison results.

For example, if the Iref is 0.2 mA, the voltage is 0.2 V when the resistance of the variable resistor 901 is 1 kilohm; the voltage is 0.4 V when the resistance of the variable resistor 901 is 2 kilohms; the voltage is 0.8 V when the resistance of the variable resistor 901 is 4 kilohms; the voltage is 1.2 V when the resistance of the variable resistor 901 is 6 kilohms; and the rest may be inferred in the same way. Vref1 to Vrefn are respectively set to 0.1 V, 0.3 V, 0.5V, 0.7V . . . . When the resistance of the variable resistor 901 is 1 kilohm, the corresponding pin state is 10000; when the resistance of the variable resistor 901 is 2 kilohms, the corresponding pin state is 11000; when the resistance of the variable resistor 901 is 4 kilohms, the corresponding pin state is 11100; and the rest may be inferred in the same way.

In this embodiment, the fixed current Iref and reference voltages Vref1 to Vrefn are originated from the chip. Thus, it is easy to establish mutual relationships between the Iref and Vref1 to Vrefn. For example, Vref1 to Vrefn may be obtained through the resistor by using the same fixed current Iref.

What has been described above is a circuit for configuring pin states in the sixth embodiment of the present disclosure. In the sixth embodiment, the variable resistor is connected to the pin so that a fixed current may be loaded on the variable resistor; the variable resistor generates different voltages under different resistance; different pin states are obtained according to the comparison between different voltages and the reference value. Because the resistance of the variable resistor may range from several tens of ohms to hundreds of kilohms, different pin states may be obtained easily.

### Seventh Embodiment

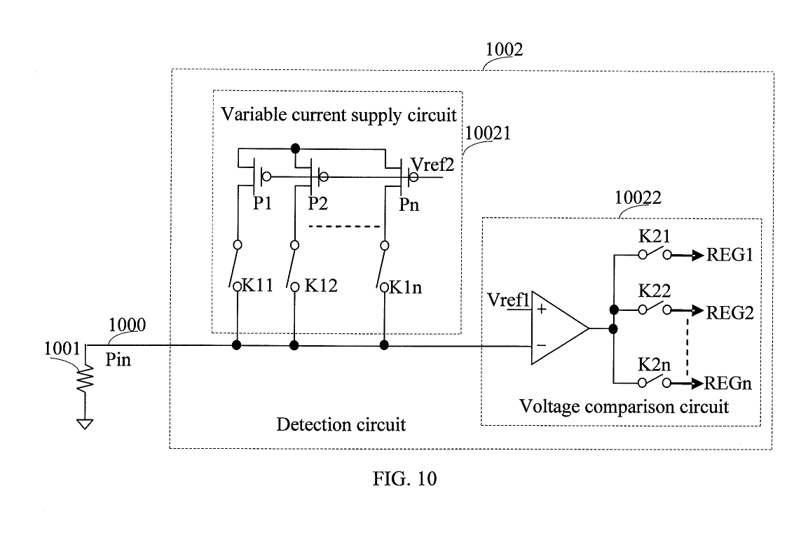

FIG. 10 shows a structure of a circuit for configuring pin states in the seventh embodiment of the present disclosure. As shown in FIG. 10, the circuit may include: a pin 1000, a variable resistor 1001, and a detection circuit 1002.

The first end of the pin 1000 is connected to the first end of the variable resistor 1001, and the second end of the variable resistor 1001 is connected to the earth. The second end of the pin 1000 is connected to the input end of the detection circuit 1002.

The detection circuit 1002 is configured to: load a variable current on the second end of the pin 1000, compare the voltages with a reference value when detecting voltages generated by the variable resistor 1001 under different resistance, and output the pin states according to the comparison results.

For example, the resistance of the variable resistor 1001 may range from several tens of ohms to hundreds of kilohms.

As shown in FIG. 10, the detection circuit 1002 may include a variable current supply circuit 10021 and a voltage comparison circuit 10022.

The variable current supply circuit 10021 is connected to the second end of the pin 1000 and configured to load a variable current on the second end of the pin 1000.

The variable current supply circuit 10021 is built by using several PMOSs (P0 to Pn) and several switches (K11 to K1n). The Vref2 is the trigger voltage of the variable current supply circuit 10021.

The voltage comparison circuit 10022 is connected to the second end of the pin 1000 and configured to: detect voltages generated by the variable resistor 1001 under different resistance, compare the voltages with a reference value, and output corresponding pin states according to the comparison results.

The voltage comparison circuit 10022 is built by using a comparator and several switches (K21 to K2n). The Vref1 is the reference voltage of the comparator.

For example, the voltage comparison circuit 10022 may compare the voltages with the reference voltage Vref1, output logic signals obtained according to the comparison with the Vref1, for example, 1 or 0, and use the logic signals as the pin states.

The width length ratios of the PMOSs may be increased according to an expected proportion to generate different currents. Switches K11 and K21 are turned on, and the value of the logic signal REG1 output by the comparator is obtained according to the judgment. Then, switches K12, K22 to K1n, and K2n are turned on in sequence, and the values of logic signals REG2 to REGn are obtained in sequence. If the judgment speed needs to be increased, the judgment may be made according to a bisection method. Supposing n is equal to 7 and only K14 and K24 are turned on, if the value of the REG4 is 1, it indicates that the values of REG1 to REG3 are 1; supposing only K16 and K26 are turned on, if the value of the REG6 is 0, the value of the REG7 is also 0; supposing only K15 and K25 are turned on, the final result may be obtained.

During the actual implementation, K11 to K1n may be turned on in turn. That is, only K11 is turned on first, and then K11 and K12 are turned on. Finally, k11 to K1n are turned on.

What has been described above is a circuit for configuring pin states in the seventh embodiment of the present disclosure. In the seventh embodiment, the variable resistor is connected to the pin so that a variable current may be loaded on the variable resistor; the variable resistor generates different voltages under different resistance; different pin states are obtained according to the comparison between different voltages and the reference value. Because the resistance of the variable resistor may range from several tens of ohms to hundreds of kilohms, different pin states may be obtained easily.

It is understandable to those skilled in the art that all or part of the steps in the preceding embodiments may be implemented by hardware instructed by a program. The program may be stored in a computer readable storage medium. When the program is executed, the steps of the preceding methods are implemented. The storage medium includes a read-only memory (ROM), a random access memory (RAM), a magnetic disk or a compact disk (CD).

Detailed above are the method and circuit for configuring pin states provided in embodiments of the present disclosure. Specific embodiments are used to describe the principle and implementation modes of the present disclosure. The preceding embodiments are only intended to help understand the method and the core idea of the present disclosure. It will be apparent to persons skilled in the art that various modifications and variations can be made to the present disclosure without departing from the scope or spirit of the present disclosure. To conclude, the present disclosure should not be limited to the specifications.

What is claimed is:

1. A method for configuring pin states, comprising:
loading a fixed voltage on a pin connected to a variable resistor;
detecting intensity of currents generated by the variable resistor under different resistance;
comparing the current intensity with at least two different reference values, and
outputting corresponding pin states according to the comparison results; or
loading a fixed current on a pin connected to a variable resistor;
detecting voltages generated by the variable resistor under different resistance;
comparing the voltages with at least two different reference values, and
outputting corresponding pin states according to the comparison results.

2. The method of claim 1, wherein comparing the current intensity with at least two different reference values and outputting the corresponding pin states according to the comparison results further comprises:
comparing the current intensity with at least two different reference values respectively;
outputting logic signals according to the comparison results; and
using the logic signal combinations as the corresponding pin states.

3. The method of claim 1, wherein comparing the voltages with at least two different reference values and outputting the corresponding pin states according to the comparison results further comprises:
comparing the voltages with at least two different reference values respectively;
outputting logic signals according to the comparison results; and
using the logic signal combinations as the pin states.

4. A method for configuring pin states comprising:
loading a variable current on a pin connected to a variable resistor;
detecting voltages generated by the variable resistor under different resistance;
comparing the voltages with a reference value, and
outputting corresponding pin states according to the comparison results.

5. The method of claim 4, wherein comparing the voltages with the reference value and outputting the corresponding pin states according to the comparison results further comprises:
comparing the voltages with the reference value respectively, and
using logic signals obtained according to the comparison results as the pin states.

6. A circuit for configuring pin states comprising
a pin;
a variable resistor, wherein a first end of the pin is connected to a first end of the variable resistor, and a second end of the variable resistor is connected to the earth; and
a detection circuit having an input end connected to a second end of the pin, wherein the detection circuit is configured to:
load a fixed voltage on the second end of the pin,
compare the current intensity with at least two different reference values when detecting intensity of currents generated by the variable resistor under different resistance, and
output corresponding pin states according to the comparison results; or
load a fixed current on the second end of the pin,
compare the voltages with at least two different reference values when detecting voltages generated by the variable resistor under different resistance, and
output corresponding pin states according to the comparison results.

7. The circuit of claim 6, wherein if the detection circuit loads a fixed voltage on the second end of the pin, the detection circuit comprises:
a fixed voltage supply circuit connected to the second end of the pin, configured to load a fixed voltage on the second end of the pin; and
a current comparison circuit connected to the second end of the pin, configured to: detect intensity of currents generated by the variable resistor under different resistance, compare the current intensity with at least two different reference values respectively, and output the corresponding pin states according to the comparison results.

8. The circuit of claim 6, wherein if the detection circuit loads a fixed current on the second end of the pin, the detection circuit comprises:
a fixed current supply circuit connected to the second end of the pin, configured to load a fixed current on the second end of the pin; and
a voltage comparison circuit connected to the second end of the pin, configured to: detect voltages generated by the variable resistor under different resistance, compare the voltages with at least two different reference values respectively, and output the corresponding pin states according to the comparison results.

9. A circuit for configuring pin states comprising:
a pin having a first end connected to a first end of a variable resistor, wherein a second end of the variable resistor is connected to the earth,
a detection circuit having an input end connected to a second end of the pin, wherein the detection circuit is configured to:
load a variable current on the second end of the pin,
compare the voltages with a reference value when detecting voltages generated by the variable resistor under different resistance, and
output corresponding pin states according to the comparison results.

10. The circuit of claim 9, wherein the detection circuit further comprises:
a variable current supply circuit connected to the second end of the pin, configured to load a variable current on the second end of the pin; and
a voltage comparison circuit connected to the second end of the pin, configured to: detect voltages generated by the variable resistor under different resistance, compare the voltages with a reference value respectively, and output the corresponding pin states according to the comparison results.
